(19) United States
(12) Patent Application Publication
(10) Pub. No.: US 2009/0071968 A1
(43) Pub. Date: Mar. 19, 2009

(54) Container

(76) Inventor: Diane O'Brien, Robbinsdale, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 12/283,298

(22) Filed: Sep. 10, 2008

Related U.S. Application Data
(60) Provisional application No. 60/993,274, filed on Sep. 11, 2007.

(51) Int. Cl. B65D 81/38; B65D 41/04; B23P 11/00

(52) U.S. Cl. 220/592.2; 220/288; 29/428; 426/418

(57) ABSTRACT

One embodiment of the container assembly of this invention includes an insulated container and at least one storage container disposable in the insulated container. The storage container can be maintained in the insulated container so that a space in the bottom of the insulated container is formed and which accommodates ice. The ice may be contacting or proximate the bottom of the storage container to maintain food present in the storage container at a desired temperature range. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### CROSS-REFERENCE TO RELATED APPLICATIONS

This application claims priority under 35 U.S.C. § 119 (e) to, and hereby incorporates by reference, U.S. Provisional Application No. 60/993,274, filed Sep. 11, 2007.

### FIELD OF THE INVENTION

This invention relates to containers and, in particular, this invention relates to containers in which food can be maintained at a desired temperature while being stored, transported, and/or served.

### SUMMARY OF THE INVENTION

This invention provides a container system in which food can be transported, stored, and/or served and in which the food is protected against being spilled and is kept at a desired temperature range (e.g. chilled). The container system further enables the food to be served in such a manner that the food is maintained within the desired temperature range.

Accordingly, there is provided a container assembly comprising an insulated container and a storage container. The insulated container may include an insulated base and a container lid, the container lid securable to the base and optionally insulated. The storage container may have a peripheral rim dimensioned to contact an upper rim of the insulated container base. The storage container may be configured to be secured within the container base by attaching the container lid to the container base. The container assembly of this invention may further include a storage container lid attaching to the storage container and/or a molding container with an optional lid for forming ice to fit between a bottom of the insulated container and the storage container.

There is also provided a method of storing food, the method including placing a storage container having the food therein and a peripheral rim in an insulated container such that the peripheral rim contacts an upper edge of the insulated container, a quantity of ice or a cooled gel pack disposed in the insulated container below the storage container; and securing an insulated container lid to the insulated container.

There is further provided a method of manufacturing a container assembly, the method including assembling an insulated container, an optionally insulated container lid, a storage container with a peripheral rim and a molding container, the peripheral rim dimensioned to contact an upper edge of the insulated container when the storage container is disposed in the insulated container, and the container lid securable to the insulated container when the storage container is disposed in the insulated container.

### BRIEF DESCRIPTION OF THE DRAWINGS

FIG. 1 is a perspective view of the container system of this invention.

FIG. 2 is a perspective view of the insulated base and a partially assembled storage container of this invention.

FIG. 2A is a perspective view of a storage container of this invention.

FIG. 3 is a perspective view of the storage container disposed in the insulated base of this invention.

FIG. 4 is a perspective view of the storage container disposed in the insulated base of this invention, sealed with a lid.

FIG. 5 is a perspective view of the storage container disposed in the insulated base of this invention, sealed with a lid, and an insulated container lid to be secured thereto.

FIG. 6 is a perspective view of the assembled container system of this invention.

It is understood that the above-described figures are only illustrative of the present invention and are not contemplated to limit the scope thereof.

### DETAILED DESCRIPTION

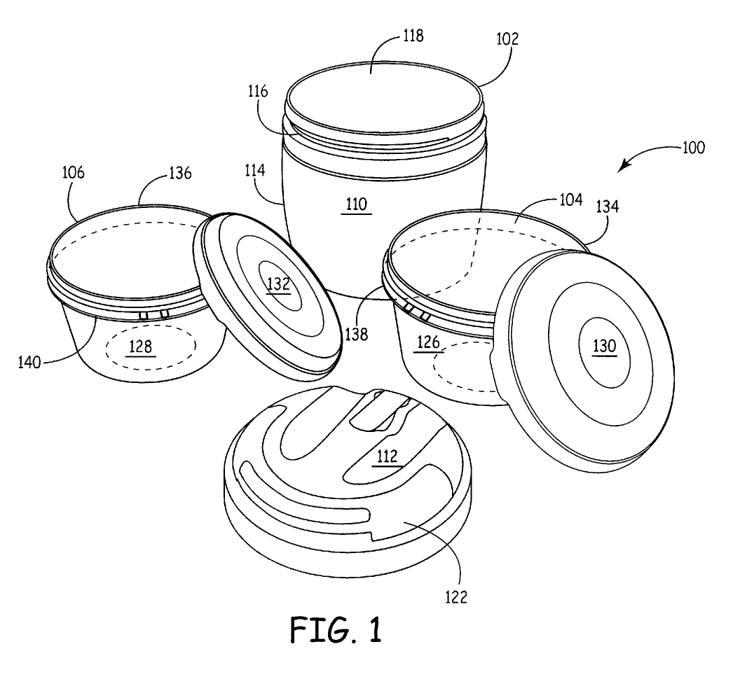

As depicted in FIG. 1, one embodiment of container assembly of this invention is depicted at 100 and includes a first insulated container 102, a second storage container 104, and a third molding container 106. The first insulated container 102, in turn, has a base 110 and an optionally insulated lid 112. The base 110 is formed by a peripheral wall 114 and a bottom (not shown). The base has external threads 116 and defines a cavity 118. The lid 112 has an optional handle 122 and internally disposed threads (not shown), which mesh with the threads 116 to sealingly and securely close the container 102. However, other mechanisms may be used to secure the lid to the container base. The respective second and third containers include container portions 126 and 128, optional lids 130 and 132, axial rims 134 and 136, and peripheral rims 138 and 140. One or more slots 143 and 144 may be defined in the respective rims 138 and 140. The rims 134 and 136 may sealingly mate with, or abut, a peripheral portion of the respective lids 130 and 132. The third molding container portion 128 is dimensioned so that when ice is formed therein, the ice fits snugly in a bottom portion of the base cavity 118. The optional lid 132 allows several of the molding containers 106 to be stacked in a freezer when ice is being formed for use.

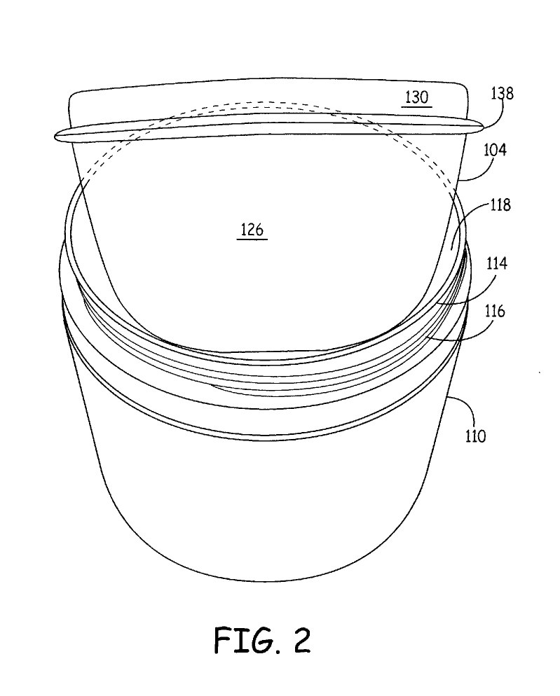

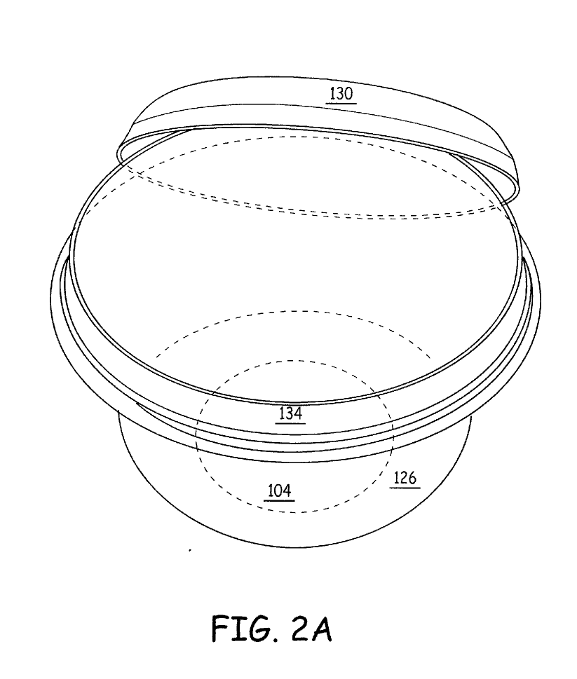

In use, the third molding container is filled to a desired level with water (e.g., to a mark placed such that about ⅔ of the container is filled) and placed in a freezer until ice has formed from the water. Alternatively, the container is dimensioned so that when it is filled, it forms an ice mass which will touch the bottom of the storage container 104 when the storage container 104 is disposed in the insulated container 102. The ice from the third molding container 106 is then removed and placed in the bottom of the insulated container base 110. The second storage container portion 126 is then placed in the base cavity 118 as shown in FIG. 2. The peripheral rim 138 is dimensioned so as to contact (abut) an upper edge of the wall 114 when the second storage container 104 is disposed within the cavity 118.

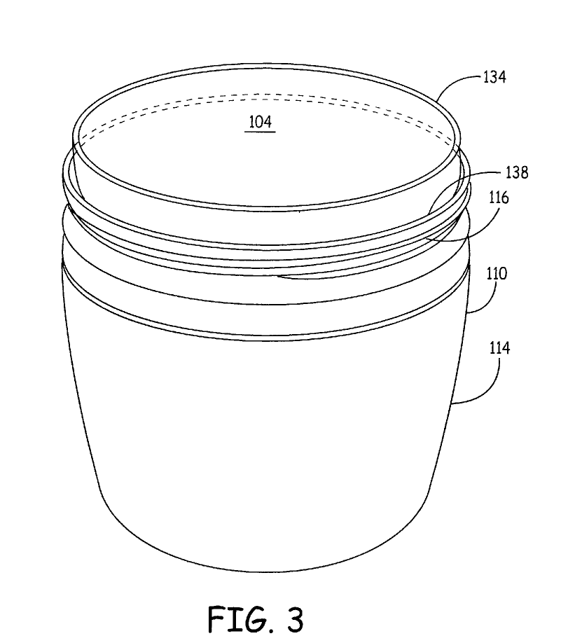

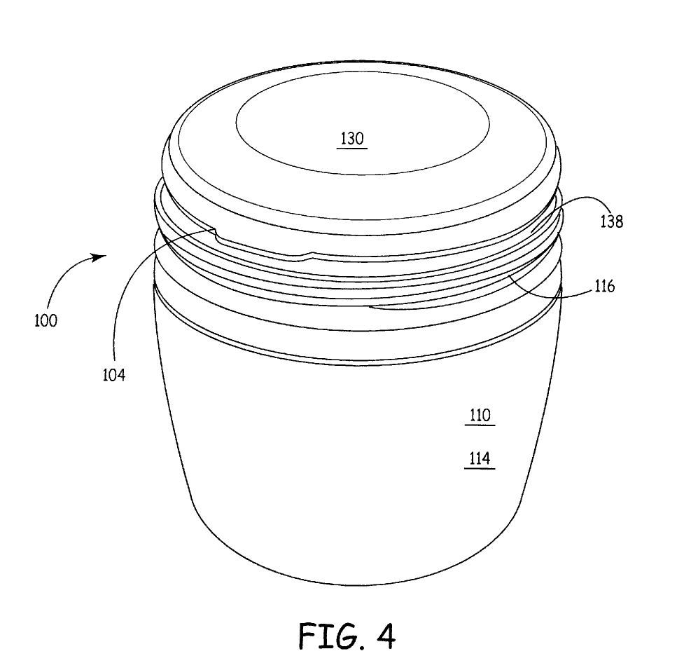

As can be seen in FIG. 3, the peripheral rim 138 maintains the container 104 above the ice disposed within the cavity 118 and further secures the second storage container in place. Accordingly, in one embodiment the peripheral rim 138 is dimensioned so that the second storage container 104 is securely held in place when the lid 112 is threaded onto the base 110. As shown in FIG. 4, the optional lid 130 may be made to securely seal the second storage container 104 when in place as shown. However, a person of ordinary skill in the art would recognize that the second storage container 104 may also be sealed when the lid 112 is secured in place as is explained more fully below.

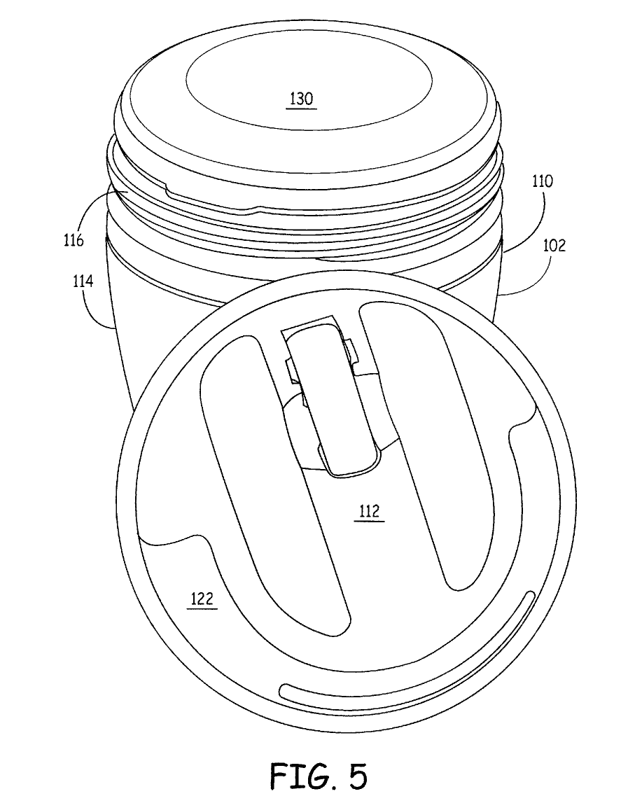

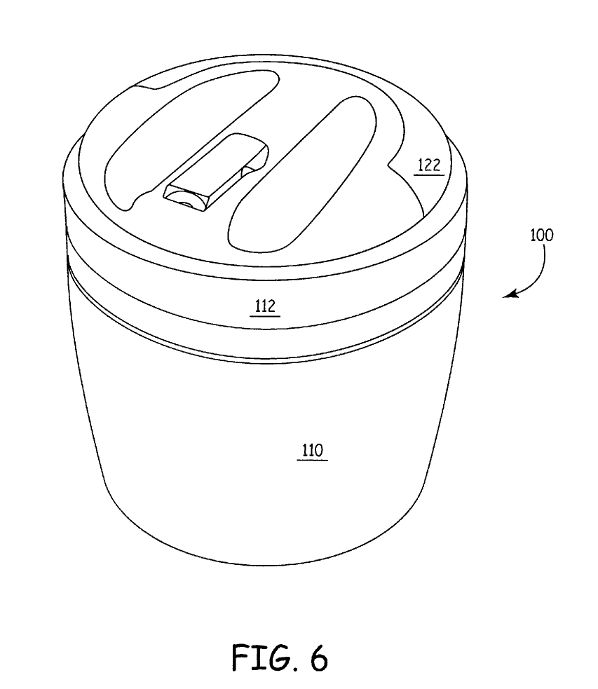

Referring now to FIGS. 5 and 6, the lid 112 is threaded onto (or other wise secured to) the container base 110 to seal the container system of this invention. Objects, such as food and refreshments, stored within the second storage container 104 are thus maintained at a target temperature range (e.g., chilled) as long as desired. Accordingly, the assembly of this invention can be accessed so as to remove the lid 112 and second storage container 104, thereby allowing the melted ice water to be discarded and additional ice, formed within the third molding container 106, placed therewithin as needed. Additionally, food in additional containers 104 can be kept refrigerated at a desired temperature, then transferred into the first insulated container 102 when desired, thereby replenishing the food to be served when desirable to do so. Food stored in this fashion, as well as being kept at a cool temperature, is thoroughly sealed and secured therewithin. Accordingly, food stored in this fashion can be transported or stored and will not be spilled or lost if the assembled container system of this invention is jarred, jostled, or displaced from the generally vertical position shown in FIG. 6 to a horizontal position. In place of ice, cooled gel packs may be desirable for some embodiments. The gel packs may be integral to the container 102 in other embodiments.

The insulated container 102 may be formed from a synthetic resin such as polyethylene, polycarbonate, or the like. In one embodiment, the insulated container base 110 is formed such that insulating material is placed within a cavity (not shown) which, in turn, is formed within the insulated container base. However, other mechanisms for insulation or for retarding heat entry or loss are known to persons of ordinary skill in the art. The second and third containers 104 and 106 may also be formed (e.g., molded) of a suitable synthetic resin such as polypropylene. In one embodiment, the synthetic resin used to form the second and third containers 104 and 106 is resiliently flexible. As also shown, the second and third containers 104 and 106 may be somewhat transparent or translucent, so that materials stored therewithin can be viewed readily. The lids 130 and 132 may be more planar (flatter) than shown to better fit within the present assembly in some embodiments. A person of ordinary skill in the art would readily find suitable synthetic resins such as listed and described in Handbook of Plastics, Elastomers, and Composites, Third Edition, Charles A. Harper, Editor in Chief, McGraw-Hill, New York (1996), hereby incorporated by reference. The containers of this invention are not to be limited to the shapes depicted. Indeed any of several shapes are contemplated to be within the scope of this invention, such as cubic, parallelepiped, triagonal (in cross section), conical (including truncated conical) or the like.

Because numerous modifications of this invention may be made without departing from the spirit thereof, the scope of the invention is not to be limited to the embodiments illustrated and described. Rather, the scope of the invention is to be determined by the appended claims and their equivalents.

What is claimed is:

1. A container assembly, comprising:
an insulated container including a base and a container lid securable to said base; and
a storage container including a peripheral rim, said storage container disposable within said insulated container and maintained in a position therewithin when said peripheral rim contacts an upper rim of said insulated container base and such that said storage container is secured within said container base by attaching said lid to said container base,
said storage container disposable within said insulated container such that a gap accommodating a piece of ice is defined therebetween.

2. The container assembly of claim 1, in which the container lid is insulated.

3. The container assembly of claim 1, further comprising a molding container dimensioned so that ice formed in the molding container is accommodated within said assembled container assembly to maintain items placed in said storage container within a desired temperature range.

4. The container assembly of claim 1, in which a slot is present in the peripheral rim of the storage container.

5. The container assembly of claim 1, in which a plurality of slots are present in the peripheral rim of the storage container.

6. The container assembly of claim 1, further comprising a molding container, wherein said piece of ice is molded, then removed from said molding container and placed in said insulated container.

7. The container assembly of claim 6, further comprising a molding container lid securable to the molding container.

8. The container assembly of claim 1, further comprising storage container lid securable to said storage container.

9. The container assembly of claim 1, in which the insulated container comprises insulated container threads and in which the container lid comprises container lid threads, the container lid threads meshing with the insulated container threads to secure the container lid to the insulated container.

10. The container assembly of claim 1, in which the storage container comprises polypropylene.

11. The container assembly of claim 1, in which the storage container comprises a transparent or translucent synthetic resin.

12. A method of storing food, comprising:
placing a storage container having the food therein and a peripheral rim in an insulated container such that the peripheral rim contacts an upper edge of the insulated container, a quantity of ice or a cooled gel pack disposed in the insulated container below the storage container; and
securing an insulated container lid to the insulated container.

13. The method of claim 12, further comprising securing a storage container lid to the storage container.

14. The method of claim 12, in which only the quantity of ice is present in the storage container.

15. The method of claim 12, in which only the gel pack is present in the storage container.

16. The method of claim 12, further comprising forming the ice by pouring liquid water in a molding container and subjecting the water in the molding container to a temperature below 0 degrees C.

17. The method of claim 16, further comprising removing the quantity of ice from the molding container and placing the quantity of ice in the insulated container.

18. A method of manufacturing a container assembly, comprising assembling an insulated container, an insulated container lid, and a storage container with a peripheral rim, the peripheral rim dimensioned to contact an upper edge of the insulated container when the storage container is disposed in the insulated container, and the insulated container lid securable to the insulated container when the storage container is disposed in the insulated container.

19. The method of claim 18, further comprising assembling a storage container lid.

20. The method of claim 18, further comprising assembling a molding container and a molding container lid.
